(19) United States
(12) Patent Application Publication
(10) Pub. No.: US 2010/0077648 A1
(43) Pub. Date: Apr. 1, 2010

(54) SIMULATED WALKING WILDFOWL DEVICE

(76) Inventor: Rodger Dale Tucker, JR., Warrenton, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/567,238

(22) Filed: Sep. 25, 2009

Related U.S. Application Data
(60) Provisional application No. 61/100,524, filed on Sep. 26, 2008.

(51) Int. Cl. A01M 31/06; B65G 17/40; B65G 47/00

(52) U.S. Cl. 43/3; 198/799; 198/617

(57) ABSTRACT

A collapsible decoy apparatus including a conveyor assembly mounted to a base, having a chain adapted to be driven in a generally elliptical pattern. A decoy support removeably attaches to a mount on the chain. The decoy support is configured to removeably attach to a decoy. The chain can move the decoy support and the decoy in a generally elliptical pattern that simulates the movement of walking wildfowl.

### CROSS-REFERENCE TO RELATED APPLICATIONS

This application is related to U.S. Provisional Patent Application No. 61/100,524 filed Sep. 26, 2008 from which priority is claimed, and is hereby incorporated by reference.

### STATEMENT REGARDING FEDERALLY SPONSORED RESEARCH

Not Applicable.

### BACKGROUND OF THE INVENTION

The present invention relates generally to decoys for attracting a predetermined species of animal, and more particularly, to moving decoys to simulate the walking motions of wildfowl.

For generations, hunters have employed numerous tactics to attract wildlife within range of the hunter's gunshot. In particular, to attract wildfowl hunters typically deploy decoys on the surface of the water or the surrounding terrain. Numerous types of decoys have been previously developed that take great care in imitating the likeness of a particular wildfowl species. Some decoys also incorporate limited motion techniques in an attempt to simulate the movements of wildfowl. However, none of the existing designs are sufficiently lifelike to consistently fool wildfowl, as they can become accustomed to and recognize the likeness of particular decoys. In addition, many of the motion techniques used are not sufficiently lifelike to fool wildfowl, but instead are unnatural movements that are recognizable to wildfowl. Moreover, conventional decoy devices that incorporate motion are large, bulky, and difficult to transport and deploy in the field

Therefore, there is a need for a portable decoy that incorporates natural and lifelike movements to consistently attract wildfowl within range of the hunter.

### DESCRIPTION OF THE DRAWINGS

In the accompanying drawings which form part of the specification:

FIG. 1 is a perspective view of a decoy apparatus, in accordance with and embodying the present invention;

FIG. 2 is another perspective view of the decoy apparatus in accordance with and embodying the present invention;

FIG. 3 is another perspective view of the decoy apparatus in accordance with and embodying the present invention;

FIG. 4 is an overhead view of the decoy apparatus in accordance with and embodying the present invention;

FIG. 5 is an enlarged perspective view of a support coupled with a mount in accordance with and embodying the present invention;

FIG. 6 is an enlarged lower perspective view of the support coupled with the mount in accordance with and embodying the present invention;

FIG. 7 is an enlarged perspective view of a mount attached to a chain in accordance with and embodying the present invention;

FIG. 8 is an enlarged overhead view of mount attached to a chain in accordance with and embodying the present invention; and

FIG. 9 is a side view of the support.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

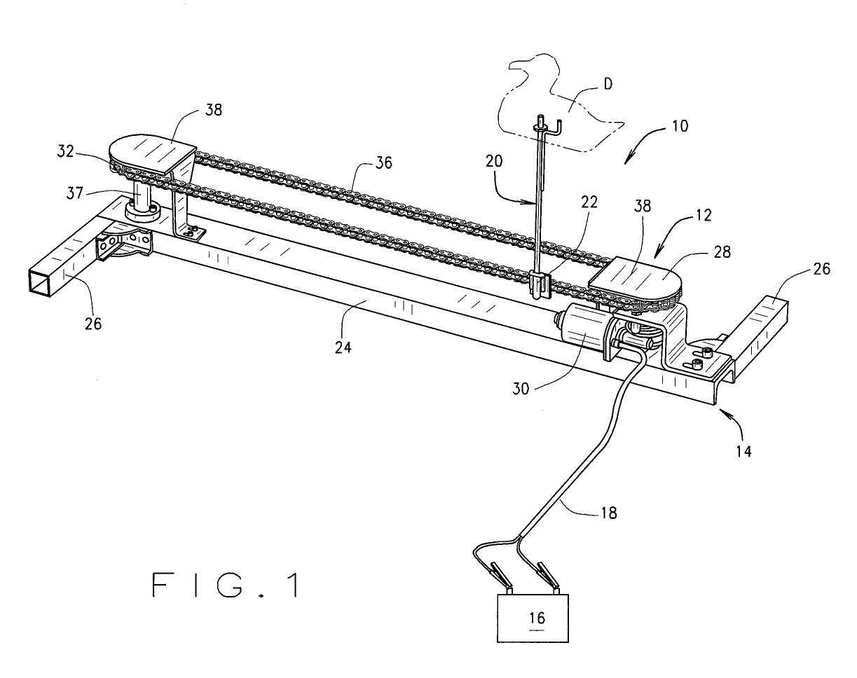

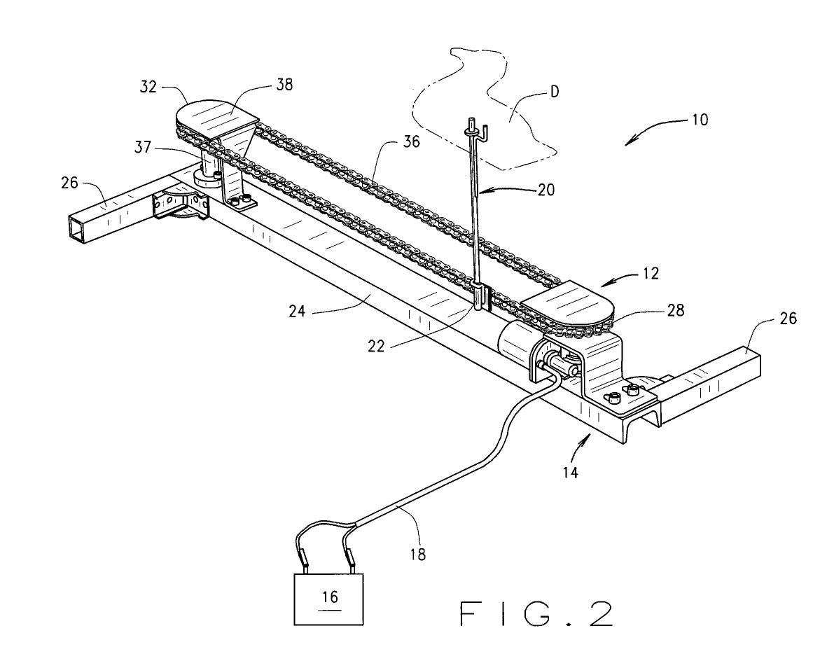

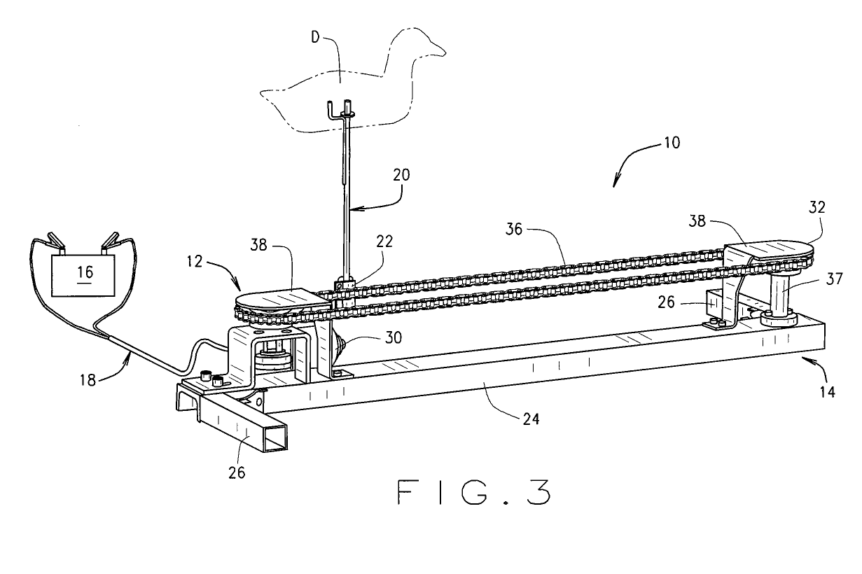

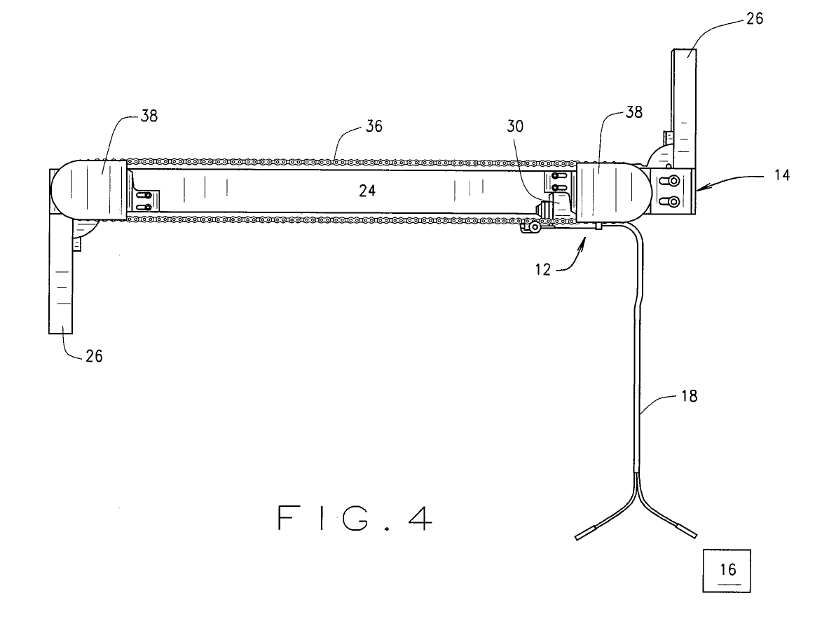

As shown in FIGS. 1-9, an embodiment of the present disclosure, generally referred to as a decoy apparatus 10, includes a conveyor assembly 12 supported by a base 14. The conveyor assembly 12 is operatively connected to a power supply 16, such as by wiring 18. A decoy support 20 removeably engages the conveyor assembly 12 with a mount 22 to support a decoy D for movement along a predetermined travel path.

The base 14 includes a generally linear beam 24, such as a U-shaped channel, with collapsible outriggers 26 or braces that are pivotally attached at opposite ends of the beam 24. The outriggers 26 pivot between an open position, with the outriggers extending generally perpendicularly from the beam 24 in opposed directions from each other, and a collapsed position, with the outriggers 26 generally parallel with and adjacent to the linear beam 24. This reduces the size of the decoy apparatus 10 to enhance its portability. Alternate embodiments can include other arrangements to further enhance the portability of the apparatus. For example, the linear beam 24 of the base 14 can be telescoping to allow the operator to reduce the length of the base 14. Alternatively, the base 14 can comprise two independent end portions that support respective driven sprocket 32 and drive sprockets 34 and that can be removeably connected with an attachment member, such as a bar.

The conveyor assembly 12 includes a drive sprocket 28 operatively connected to a motor 30, and a driven sprocket 32 operatively connected to the drive sprocket 34 with an endless chain 36. The drive sprocket 34 and driven sprocket 32 are pivotally mounted, such as with bearings, to the linear beam 24 of the base 14 with supports 37, so that the drive sprocket 34 and driven sprocket 32 are located at about the same elevation. The chain 36 engages the drive sprocket 34 and the driven sprocket 32 with an appropriate amount of tension to remain engaged and support the decoy support 20. Generally L-shaped guards 38 attach to the linear beam 24 and extend generally upwardly to cover the upper portion of respective drive sprocket 34 and driven sprocket 32. The motor 30 is preferably mounted to the base 14 and is preferably a direct current motor, but those skilled in the art will recognize that any type of motor can be used. The power supply 16 is preferably a portable battery, such as a 12-volt battery. However, any type of power source can be used. If desired, the power supply 16 can be mounted on the base 14 with an appropriate fastener.

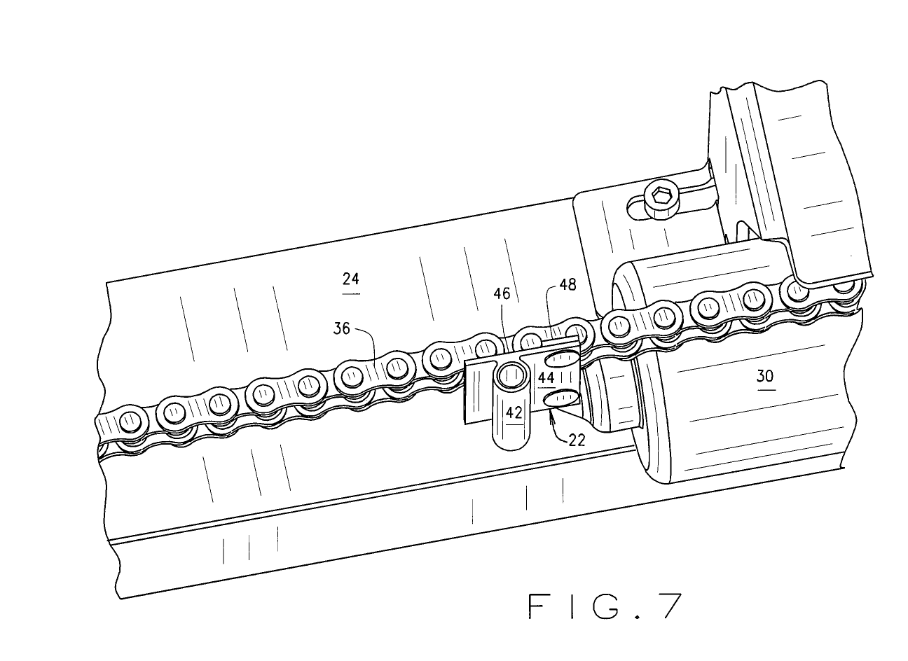

The mount 22 is a generally rectangular plate 40 having a cylinder defining an elongated vertical socket 42 along an outer face 44 for receiving the decoy support 20 (FIG. 7-8). An inner face 46 of the mount 22 attaches to the chain 36, such as by welding, adhesive, or other appropriate means. A spacer 48 attaches between the inner face 46 of the mount 22 and the chain 36, such as by welding, adhesive, or other appropriate means, to accommodate for the non-planar shape of the chain 36 so that the mount 22 is generally parallel with the chain 36. Those skilled in the art will recognize that the mount 22 can comprise any arrangement capable of removeably attaching the decoy support 20 to the chain 36.

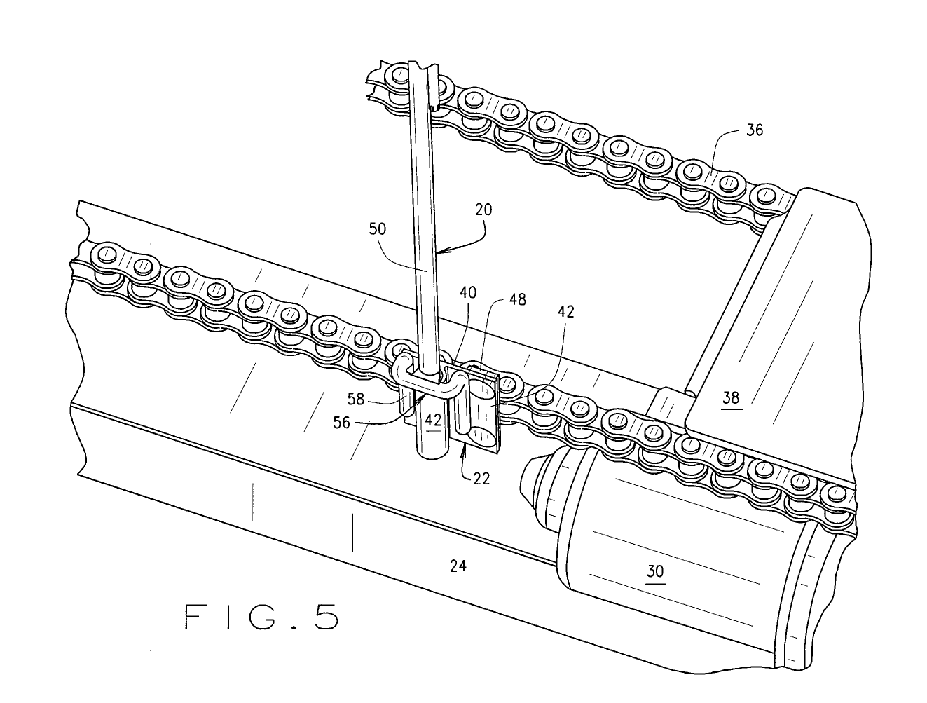

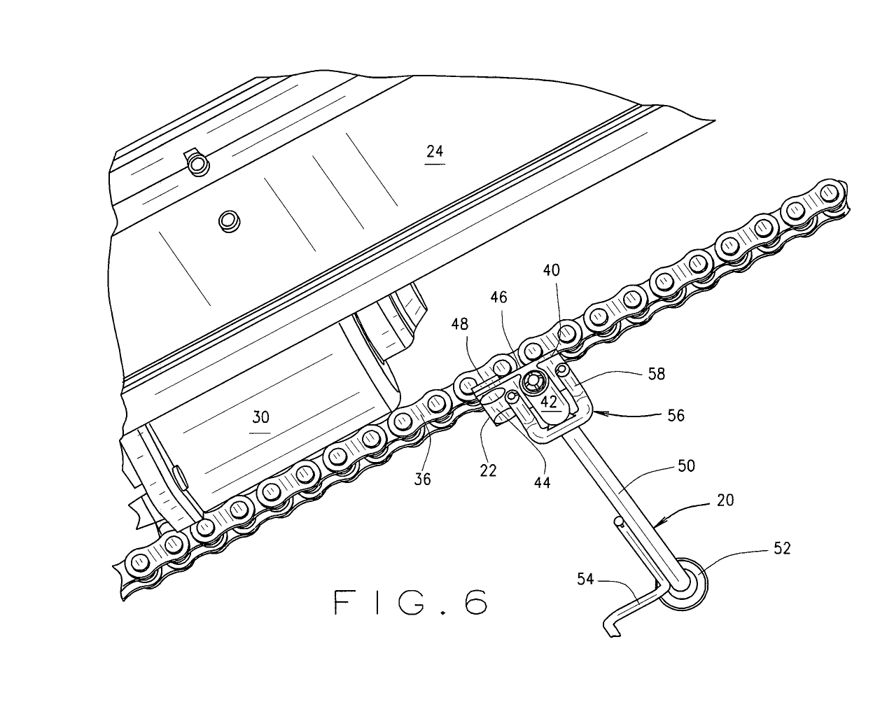

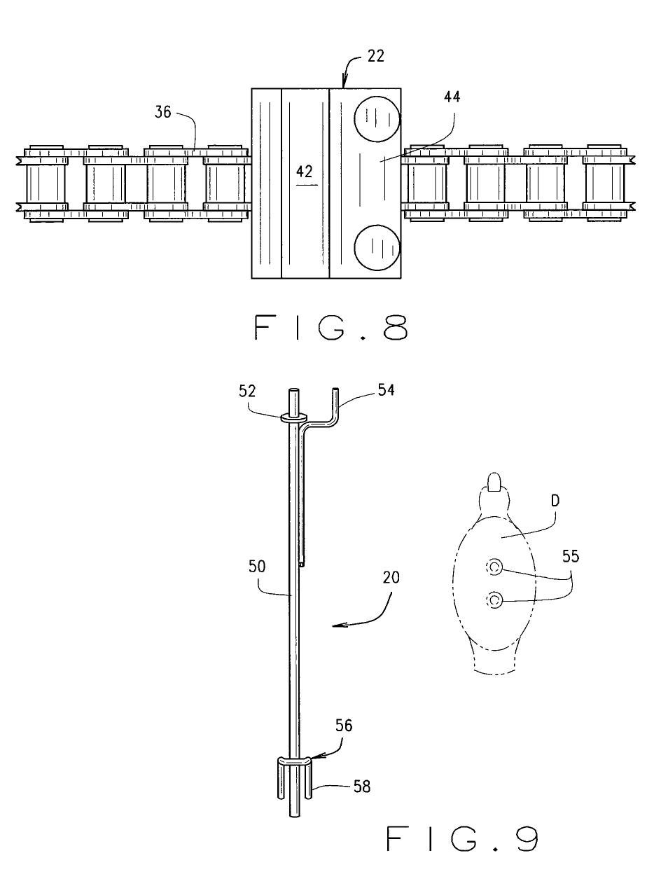

The decoy support 20 includes a post 50 with a stop 52 near the upper end of the post 50 and an alignment member 54 attached to the post 50 (FIG. 9). The stop 52, the upper end of the post 50, and the alignment member 54 are positioned relative to each other to engage a corresponding mounting hole pattern 55 on the decoy D. Those skilled in the art will recognize that other arrangements of the post 50 and alignment member 54 can be used to correspond to multiple types of decoys and mounting hole patterns 55. A generally U-shaped brace 56 with a pair of prongs 58 attaches, such as by welding, adhesive, or other appropriate means, near the lower end of the post 50 for engagement with the mount 22. When assembled, the post 50 inserts into the socket 42 and the prongs 58 rest against the outer face 44 of the mount 22 to provide lateral support to the decoy support 20 (FIG. 5-6). For transporting the apparatus 10, the decoy support 20 can be removed from the mount 22 and the decoy D to enhance portability.

In operation, the outriggers 26 are pivoted to the open position and the decoy apparatus 10 is placed on the ground in a desired location. The decoy D attaches to the upper end of the decoy support 20, and the decoy support 20 attaches to the mount 22. An operator connects a power supply 16 to the wiring 18 and turns on the motor 30. The motor 30 turns the drive sprocket 34, which in turn advances the chain 36 about the drive sprocket 34 and the driven sprocket 32 in a generally elliptical pattern. In turn, the chain 36 moves the mount 22, decoy support 20, in an elliptical pattern so that the decoy D advances in a forward position and generally parallel with the ground. This movement of the decoy D simulates the walking movement of a walking wildfowl, such as a goose, duck, or other wildfowl. When the hunter is finished hunting, the decoy D, and decoy support remove 20, and the outriggers 26 fold up for easy transport and storage.

All of the elements of the decoy apparatus are preferably constructed from all-weather materials capable of withstanding the outdoor environment, such as metal or plastic materials.

Changes can be made in the above constructions without departing from the scope of the invention, it is intended that all matter contained in the above description or shown in the accompanying drawings shall be interpreted as illustrative and not in a limiting sense. For example, alternate embodiments, can be used for rabbit or coyote, with adjusted speeds and decoy supports. In addition, a chain tensioner can be used to maintain proper tension on the chain 36 during operation. For example, a chain tensioner can be attached to the base 24 and engage the chain 36 to maintain proper tension. Alternatively, a chain tensioner can be incorporated into the drive sprocket 34 or driven sprocket 32.

What is claimed is:

1. A decoy apparatus, comprising:
a base;
a conveyor assembly mounted to the base, having a chain adapted to be driven in a generally elliptical pattern, and having a mount attached to chain;
a decoy support removeably attached to the mount and configured to removeably attach to a decoy; and
wherein the chain can move the decoy support and the decoy in a generally elliptical pattern that is generally parallel with the ground and that simulates the movement of walking wildfowl.

2. The decoy apparatus of claim 1, the base comprising:
a linear beam;
at least one outrigger pivotally attached to the end of the linear beam so that the outrigger can move between an open position being generally perpendicular to the linear beam and collapsed position being generally parallel and adjacent to the linear beam.

3. The decoy apparatus of claim 1, the decoy support comprising:
a post having a lower end shaped and sized to removeably attach to the mount; and
an alignment member attached to an upper end of the post, the alignment member having a portion spaced from the post so that the portion of the alignment member and the post are configured to correspond with a mounting hole pattern of the decoy.

4. The decoy apparatus of claim 1, further comprising:
a collapsible outrigger attached to the base; and
wherein the decoy support is sized and shaped for removal from the conveyor assembly and the decoy to enhance the portability of the decoy apparatus.

5. The decoy apparatus of claim 1, the mount comprising:
a plate having an inner face attached to the chain; and
an cylinder attached to an outer face of the plate, the cylinder defining an elongated generally vertical socket being sized and shaped to receive the decoy support.

6. The decoy apparatus of claim 1, the conveyor assembly further comprising:
a drive sprocket engaged with the chain and positioned at about one end of the base;
a driven sprocket engaged with the chain and positioned on the base at a predetermined distance from the drive sprocket;
a motor operatively connected to the drive sprocket; and
a power supply operatively connected to the motor.

7. The decoy apparatus of claim 6, further comprising a guard attached to the base and positioned to generally cover an upper portion of the drive sprocket.

8. A system for attracting wildfowl, comprising:
a collapsible base;
a conveyor assembly mounted to the base, having a chain capable of being driven in a generally elliptical pattern, and having a mount attached to chain;
a decoy support removeably attached to the mount for supporting a decoy
a decoy removeably attached to the decoy support, wherein the chain moves the decoy support and the decoy in a generally elliptical pattern that is generally parallel with the ground that simulates the movement of walking wildfowl;
a drive sprocket engaged with the chain and positioned at about one end of the collapsible base;
a driven sprocket engaged with the chain and positioned at about an opposite end of the collapsible base in a generally planar relationship with the drive sprocket;
a motor operatively connected to the drive sprocket; and
a power supply operatively connected to the motor.

9. The decoy apparatus of claim 8, the base comprising:
a linear beam;
at least one outrigger pivotally attached to the end of the linear beam so that the outrigger can move between an open position being generally perpendicular to the linear beam and collapsed position being generally parallel and adjacent to the linear beam.

10. The decoy apparatus of claim 8, the decoy support comprising:
a post having a lower end shaped and sized to removeably attach to the mount; and
an alignment member attached to an upper end of the post, the alignment member having a portion spaced from the post so that the portion of the alignment member and the post are configured to correspond with a mounting hole pattern of the decoy.

11. The decoy apparatus of claim 8, further comprising:
a collapsible outrigger attached to the base; and
wherein the decoy support is sized and shaped for removal from the conveyor assembly and the decoy to enhance the portability of the decoy apparatus.

12. The decoy apparatus of claim 8, the mount comprising:
a plate having an inner face attached to the chain; and
an cylinder attached to an outer face of the plate, the cylinder defining an elongated generally vertical socket being sized and shaped to receive the decoy support.

13. A method of attracting wildfowl, comprising:
providing a base;
providing a conveyor assembly mounted to the base, having a chain adapted to be driven in a generally elliptical pattern;
providing a mount attached to chain;
providing a decoy support removeably attached to the mount and configured to removeably attach to a decoy;
providing a decoy removeably attached to the decoy support;
providing a power supply;
attaching the decoy support to the mount;
attaching the decoy to the decoy support;
connecting the conveyor assembly to the power supply; and
advancing the chain, the mount, the decoy support, and the decoy in a generally elliptical pattern that is generally parallel with the ground and that simulates the movement of walking wildfowl.

14. The method of attracting wildfowl of claim 12, further comprising:
removing the decoy from the decoy support;
removing the decoy support from the mount;
providing a collapsible outrigger attached to the base; and
moving the outrigger to a collapsed position.

15. The method of attracting wildfowl of claim 12, wherein the conveyor assembly comprises:
a drive sprocket engaged with the chain and positioned at about one end of the base;
a driven sprocket engaged with the chain and positioned on the base at a predetermined distance from the drive sprocket;
a motor operatively connected to the drive sprocket; and
a power supply operatively connected to the motor.

16. The method of attracting wildfowl of claim 12, wherein the base comprises:
a linear beam; and
at least one outrigger pivotally attached to the end of the linear beam so that the outrigger can move between an open position being generally perpendicular to the linear beam and collapsed position being generally parallel and adjacent to the linear beam.

17. The method of attracting wildfowl of claim 12, wherein the mount comprises:
a plate having an inner face attached to the chain; and
an cylinder attached to an outer face of the plate, the cylinder defining an elongated generally vertical socket being sized and shaped to receive the decoy support.

18. The method of attracting wildfowl of claim 12, wherein the decoy support comprises:
a post having a lower end shaped and sized to removeably attach to the mount; and
an alignment member attached to an upper end of the post, the alignment member having a portion spaced from the post so that the portion of the alignment member and the post are configured to correspond with a mounting hole pattern of the decoy.
